(19) United States
(12) Patent Application Publication
(10) Pub. No.: US 2025/0259166 A1
(43) Pub. Date: Aug. 14, 2025

(54) System and method for coupon payment system for electric vehicle charging

(71) Applicant: Electronic Power Design, Inc., Houston, TX (US)

(72) Inventor: JOHN BRADFORD JANIK, Houston, TX (US)

(73) Assignee: Electronic Power Design, Inc., Houston, TX (US)

(21) Appl. No.: 19/011,742

(22) Filed: Jan. 7, 2025

Related U.S. Application Data
(60) Provisional application No. 63/618,406, filed on Jan. 8, 2024.

(51) Int. Cl. G06Q 20/38; G06Q 30/0207; G06Q 30/0238; G06Q 50/06; G07B 15/02

(52) U.S. Cl. CPC G06Q 20/387; G06Q 30/0213; G06Q 30/0238; G06Q 50/06; G07B 15/02

(57) ABSTRACT

A billing system and method that allows customers to offset their electric vehicle charging and parking expenses at a grocery store through a coupon.

### CROSS REFERENCE TO RELATED PATENT APPLICATIONS

This patent application claims priority from U.S. provisional patent application Ser. No. 63/618,406 entitled A SYSTEM AND METHOD FOR COUPON BAR CODE PAYMENT SYSTEM FOR ELECTRIC VEHICLE CHARGING AND PARKING by Janik, filed on Jan. 8, 2024, which is hereby incorporated by reference in its entirety.

### BACKGROUND OF THE INVENTION

As electric vehicles proliferate, the need for conveniently charging electric vehicles is expanding.

### FIELD OF THE INVENTION

The present invention relates to the field of electric vehicle charging.

### BRIEF DESCRIPTION OF THE DRAWINGS

The drawings presented herein are for illustrative purposes only and do not limit the scope of the claims. Rather, the drawings are intended to help enable one having ordinary skill in the art to make and use the claimed inventions. The drawings are drawn to scale.

FIG. 1 depicts an illustrative embodiment of the invention.

### SUMMARY OF THE INVENTION

This system offers a distinctive and efficient payment method for Electric Vehicle users. It streamlines the billing process by allowing customers to offset their charging and parking expenses through a coupon generated by the system. The coupon can be a bar code printed on their grocery store receipt, or an electronic coupon set to their phone. The coupon is used to pay for parking and electric vehicle charging.

### DETAILED DESCRIPTION OF A PARTICULAR ILLUSTRATIVE EMBODIMENT OF THE INVENTION

A detailed description will now be provided. The purpose of this detailed description, which includes the drawings, is to satisfy the statutory requirements of 35 U.S.C. § 112. For example, the detailed description includes a description of inventions defined by the claims and sufficient information that would enable a person having ordinary skill in the art to make and use the inventions. In the figures, like elements are generally indicated by like reference numerals regardless of the view or figure in which the elements appear. The figures are intended to assist the description and to provide a visual representation of certain aspects of the subject matter described herein. The figures are not all necessarily drawn to scale, nor do they show all the structural details, nor do they limit the scope of the claims.

The present invention discloses about an “Coupon Bar Code Payment System for Electric Vehicle Charging and Parking” has the following features.

A unique Payment Method: This system offers a distinctive and efficient payment method for Electric Vehicle users (hereinafter “User”). It streamlines the billing process by allowing users such as grocery store customers to offset their EV charging and parking expenses through a coupon generated by the system. The coupon can be a bar code printed on their grocery store receipt, and an electronic coupon set to their phone. The coupon is recognized by a parking fee collections system and an electric vehicle charging fee collection system and used to pay for parking and electric vehicle charging. The coupon is good at any store in an enterprise of multiple stores. The system communicates with all store systems in the enterprise, so that the coupon is recognized at any store in the enterprise. The coupon, bar code or electronic coupon is sent over the internet to a data base accessible to all stores in the enterprise so that the bar code and electronic coupon is redeemable at any store in the enterprise of stores. Thus a use can buy groceries at one store, receive a coupon, bar code or electronic, and can be redeemed by the user for parking and EV charging at any store in the enterprise of stores.

Dual-Functionality: The coupon serves a dual purpose. It not only facilitates EV charging payment but also used to pay parking fees. This dual functionality is a significant advantage for consumers, as it simplifies their experience and ensures a seamless transition between parking and shopping while their EV is being charged.

Convenience for Shoppers: With this system in place, customers can park their Electric Vehicles at designated charging stations and proceed with their shopping activities. This added convenience eliminates the need for separate payment transactions for parking and charging, saving time and effort. Cost Savings: By integrating the payment for EV charging and parking into a single coupon bar code, customers may benefit from potential cost savings. This innovative approach could lead to discounts or incentives, making EV usage more economical.

Environmental Sustainability: Encouraging the use of Electric Vehicles through a more straightforward and cost-effective payment system can contribute to reduced carbon emissions and promote environmental sustainability. This aligns with the global effort to transition to greener transportation options.

The present invention provides a coupon payment system that simplifies and enhances the experience of using electric vehicle charging stations while shopping. By consolidating the grocery, EV charging and parting payment systems and offering a dual-function coupon, the present invention encourages more consumers to adopt EVs, ultimately contributing to a cleaner and more sustainable future.

Each of the appended claims defines a separate invention which, for infringement purposes, is recognized as including equivalents of the various elements or limitations specified in the claims. Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions, and examples, but the inventions are not limited to these specific embodiments, versions, or examples, which are included to enable a person having ordinary skill in the art to make and use the inventions when the information in this patent is combined with available information and technology. Various terms as used herein are defined below, and the definitions should be adopted when construing the claims that include those terms, except to the extent a different meaning is given within the specification or in express representations to the Patent and Trademark Office (PTO). To the extent a term used in a claim is not defined below or in representations to the PTO, it should be given the broadest definition persons having skill in the art have given that term as reflected in at least one printed publication, dictionary, or issued patent.

Certain specific embodiments of methods, structures, elements, and parts are described below, which are by no means an exclusive description of the inventions. Other specific embodiments, including those referenced in the drawings, are encompassed by this application and any patent that is issued therefrom.

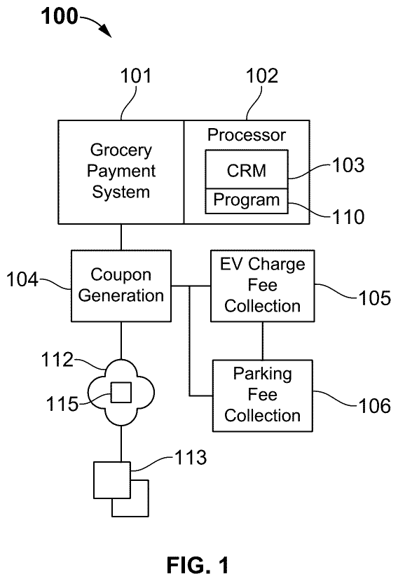

Turning now to FIG. 1, as shown in FIG. 1, in an illustrative embodiment of the present invention 100, a store payment system 100 provides, a store payment system 101, a payment processor 102, a non-transitory computer readable medium 103, a coupon generator 104, an electric vehicle charging station fee collection system 105 and a parking fee payment collection system 106. A user purchases goods at a grocery store and redeems bonuses for addition credits for purchases in the store. In a particular he coupon can be a bar code printed on a grocery receipt based on the users purchases and bonus credits in the store. . . . The coupon can also be an electronic coupon sent to a user's cell phone. Both types of coupons generated by the system are recognized by the parking and EV charging Fee collection systems. A grocery store customer pays for goods, including but not limited to groceries at the payment system 101. A processor 102 running a computer program stored in the non-transitory computer readable medium 103. A dual function coupon, for example, a barcode is printed on a store receipt generated by the coupon generation module 104. In one example of the invention, the dual function coupon is bar code. The dual function coupon, such as a bar code or electronic coupon is generated and accepted as payment at an electric vehicle charging station fee collection system to pay for EV charging and at a parking fee collection system to pay for parking at the grocery store. The payment system is connected to the coupon generator.

In an illustrative embodiment, the store payment system 100 is a member of an enterprise of multiple stores store payment systems 113 that are a member of the enterprise and are connected by the internet 112 as shown in FIG. 1. The coupon generator sends the coupon to an enterprise database 115 accessible over a network 112. The database is accessible by all store payment systems in the enterprise so that the coupon in the database is accessible over the network by all other stores 113 in the enterprise so that the coupon is redeemable at all payment and fee collection systems in the enterprise of stores. The enterprise database is stored in a data structure in a non-transitory computer readable medium.

Each of the appended claims defines a separate invention which, for infringement purposes, is recognized as including equivalents of the various elements or limitations specified in the claims. Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions, and examples, but the inventions are not limited to these specific embodiments, versions, or examples, which are included to enable a person having ordinary skill in the art to make and use the inventions when the information in this patent is combined with available information and technology. Various terms as used herein are defined below, and the definitions should be adopted when construing the claims that include those terms, except to the extent a different meaning is given within the specification or in express representations to the Patent and Trademark Office (PTO). To the extent a term used in a claim is not defined below or in representations to the PTO, it should be given the broadest definition persons having skill in the art have given that term as reflected in at least one printed publication, dictionary, or issued patent.

Certain specific embodiments of methods, structures, elements, and parts are described below, which are by no means an exclusive description of the inventions. Other specific embodiments, including those referenced in the drawings, are encompassed by this application and any patent that issues therefrom.

1. A coupon payment system, the system comprising:
a store payment station for customer payment for goods;
a processor connected to the store payment system;
a coupon generator connected to the store payment system that generates a coupon based on purchases at the store; and
a electric vehicle charging fee station fee collection system that accepts the coupon as payment for electric vehicle charging.

2. The coupon payment system of claim 1, further comprising:
a parking fee collection system that accepts the coupon for parking at the store.

3. The coupon payment system of claim 1, wherein the coupon is a coupon bar code printed on a receipt for payment for goods.

4. The coupon payment system of claim 1, wherein the coupon is an electronic coupon sent to a user cell phone.

5. The coupon payment system of claim 1, wherein the coupon is a dual function coupon that is accepted at an electric vehicle charging station fee collection system and a parking fee collection system.

6. The coupon payment system of claim 1, wherein the store is a member store in an enterprise of a plurality of stores, wherein the coupon is an enterprise coupon that is accepted for payment of electric vehicle charging fees at any store and and any electric vehicle charging fee collection system in the enterprise, the coupon payment system further comprising:
a network wherein the coupon is sent over the network to a data base accessible by all stores in the enterprise connected to the network.

7. A method for accepting a coupon payment, the method comprising:
generating a coupon at a store payment system for payment for goods; and
accepting the coupon at a electric vehicle charging fee station that accepts the coupon.

8. The method for accepting a coupon payment claim 7, further comprising:
accepting the coupon at a parking system fee collection system that accepts the coupon.

8. The method for accepting a coupon payment of claim 7, wherein the coupon is a coupon bar code printed on a receipt for payment for goods.

9. The method for accepting a coupon payment of claim 7, wherein the coupon is a electronic coupon sent to a user cell phone.

10. The method of claim 7, wherein the store payment system is a member store payment system in an enterprise comprising a plurality of store payment systems, wherein the coupon is an enterprise coupon, the method further comprising:
sending the coupon over a network to a data base accessible by all store payment systems in the enterprise, over an electronic network; and
accepting the enterprise coupon for payment of electric vehicle charging fees at any electric vehicle charging fee collection system in the enterprise of store payment systems.
